(19) United States
(12) Patent Application Publication
(10) Pub. No.: US 2009/0106311 A1
(43) Pub. Date: Apr. 23, 2009

(54) SEARCH AND FIND SYSTEM FOR FACILITATING RETRIEVAL OF INFORMATION

(76) Inventors: LIOR HOD, TEANECK, NJ (US); KAMAL PATEL, PARAMUS, NJ (US)

Correspondence Address: GREENBERG TRAURIG, LLP, 200 PARK AVE., P.O. BOX 677, FLORHAM PARK, NJ, 07932, US

(21) Appl. No.: 11/875,058

(22) Filed: Oct. 19, 2007

(51) Int. Cl. G06F 17/30

(52) U.S. Cl. 707/104.1; 707/E17.001

(57) ABSTRACT

The present invention relates to an apparatus and a method for use in retrieving information from a physician practice management system and providing the retrieved information to a laboratory information system. The physician practice management system includes a first database for storing therein a plurality of first patient records, each of which corresponds to a patient. The apparatus includes an application for generating a search request based on a search criterion supplied by a user and a second database for storing a plurality of second records, each of which corresponds to one of the first records stored in the first database. The apparatus also includes a search engine for conducting a search through the second database in response to the search request received from the application and for retrieving at least one of the second records based on the search criterion. The application is configured to provide to the user the at least one of the second records retrieved from the second database. In accordance with an embodiment of the present invention, the apparatus is provided with a synchronizing system for synchronizing the second records with the first records.

### FIELD OF THE INVENTION

The present invention relates to a search and find system and, more particularly, to a search and find system for facilitating retrieval of patient information.

### BACKGROUND OF THE INVENTION

In the medical industry, various systems have been in use to assist physicians with their medical practice. For instance, with reference to FIG. 1, a physician practice management system (PMS) 10 has been used by physicians to store and manage patient information, including patient demographic information (e.g., patient names, addresses, birth dates, social security numbers, etc.) and billing/insurance information, as well as account information (e.g., information regarding outstanding bills, payment histories, etc.). The physician management system 10 has also been used to perform various tasks (e.g., to issue bills to patients, to prepare, submit and manage insurance claims, etc.). The physician management system 10 typically includes a PMS database 12 for storing patient information therein and a PMS user-interface application 14 for entering, retrieving and/or otherwise managing same.

A laboratory information system 16 has also been in use in the medical industry. The laboratory information system 16 is typically provided by a diagnostics laboratory, such as Quest Diagnostics, Inc. and Laboratory Corporation of America (a/k/a “LabCorp”), to physicians for use in ordering diagnostics tests for patients. Some laboratory information systems 16 allow physicians to view the results of the ordered tests upon their completion. Most laboratory information systems 16 are web-based applications which can be accessed by physicians via the Internet to order diagnostics tests. The laboratory information system 16 is also known as “laboratory outreach system” when it is provided to a hospital-based laboratory.

The laboratory information system 16 is typically configured to provide on-line requisition or request forms for use by physicians in ordering diagnostics tests for patients. The requisition forms are completed by inserting the required information (e.g., patient demographic information, including the patient name, address, etc., insurance information and tests to be ordered) into various fields provided thereon.

A bridge 18 may be provided to expedite the preparation of requisition forms using live data. Prior to bridges, ASCIIs and one-time continuous data-dumps were used to update information. Because the laboratory information system 16 and the physician management system 10 are typically non-standardized applications which are unable to communicate, and hence exchange data, directly with one another, the bridge 18 (also known as “demographic interface” or “demographic bridge”) is designed to interact with the laboratory information system 16 and the physician management system 10. Accordingly, when a requisition form is being prepared, the laboratory information system 16 sends a request to the bridge 18 for retrieval of patient information from the physician management system 10. In response to the request, the bridge 18 accesses the PMS database 12 of the physician management system 10 and extracts the requested patient data therefrom. The extracted patient data is then supplied by the bridge 18 to the laboratory information system 16 for auto-insertion into corresponding fields provided on the requisition form. Since the required patient data is imported directly into the requisition form from the physician management system 10, the foregoing process ensures that the data inserted therein is accurate (i.e., at least as accurate as the information stored in the PMS database 12 of the physician management system 10), thereby minimizing typographical errors which could occur when the required patient data is manually typed into the requisition form.

To import the required patient data from the physician management system 10 into a requisition form, the bridge 18 needs to be provided with a unique patient identifier (e.g., a chart number, a social security number or other identifier corresponding to the patient) so that it can locate corresponding patient data in the PMS database 10 of the physician management system 12. Accordingly, if the required patient identifier is not previously known by the physician, it must be ascertained by the physician by manually looking up the patient chart. As a result, the overall process of completing the requisition form may be delayed and/or is inefficient.

### SUMMARY OF THE INVENTION

The present invention relates to an apparatus for use in retrieving information from a physician practice management system and providing the retrieved information to a laboratory information system. The physician practice management system includes a first database for storing therein a plurality of first patient records, each of which corresponds to a patient. The apparatus includes an application for generating a search request based on a search criterion supplied by a user and a second database for storing a plurality of second records, each of which corresponds to one of the first records stored in the first database. The apparatus also includes a search engine for conducting a search through the second database in response to the search request received from the application and for retrieving at least one of the second records based on the search criterion. The application is configured to provide to the user the at least one of the second records retrieved from the second database. In accordance with an embodiment of the present invention, the apparatus is provided with a synchronizing system for synchronizing the second records with the first records.

The present invention also relates to a method for use in retrieving information from a physician practice management system and providing the retrieved information to a laboratory information system. The physician practice management system includes a first database for storing therein a plurality of first patient records, each of which corresponds to a patient. The method includes the steps of generating a search request based upon a search criterion supplied by a user and conducting a search through a second database in response to the search request. The second database is configured to store therein a plurality of second records, each of which corresponds to one of the first records stored in the first database. The method also includes the steps of retrieving at least one of the second records from the second database based on the search criterion and providing the at least one of the second records retrieved from the second database to the user.

### BRIEF DESCRIPTION OF THE DRAWINGS

For a more complete understanding of the present invention, reference is made to the following detailed description of the exemplary embodiments considered in conjunction with the accompanying drawings, in which:

FIG. 1 is a schematic view of conventional systems utilized in the medical industry for storing and retrieving patient data;

FIG. 2 is a schematic view of an apparatus constructed in accordance with the present invention;

FIG. 3 is a schematic view of a search and find system constructed in accordance with the present invention;

FIG. 4 is a view of a search screen shot provided by the search and find system of FIG. 3;

FIG. 5 is a schematic view of a bridge constructed in accordance with the present invention;

FIG. 6 is a schematic flow chart illustrating a process of the present invention for importing patient information into a laboratory information system from a physician practice management system;

FIG. 7 is a schematic diagram illustrating a process performed during a search and find session in accordance with the present invention;

FIG. 8 is a schematic diagram illustrating a process performed during a bridge look-up session in accordance with the present invention;

FIG. 9 is a schematic flow chart illustrating a modified version of the process shown in FIG. 6;

FIG. 10 is a view of a search screen shot utilized during the performance of the modified process of FIG. 9;

FIG. 11 is a schematic view of a data synchronizer constructed in accordance with the present invention; and

FIG. 12 is a schematic diagram illustrating a process performed by the data synchronizer of FIG. 11.

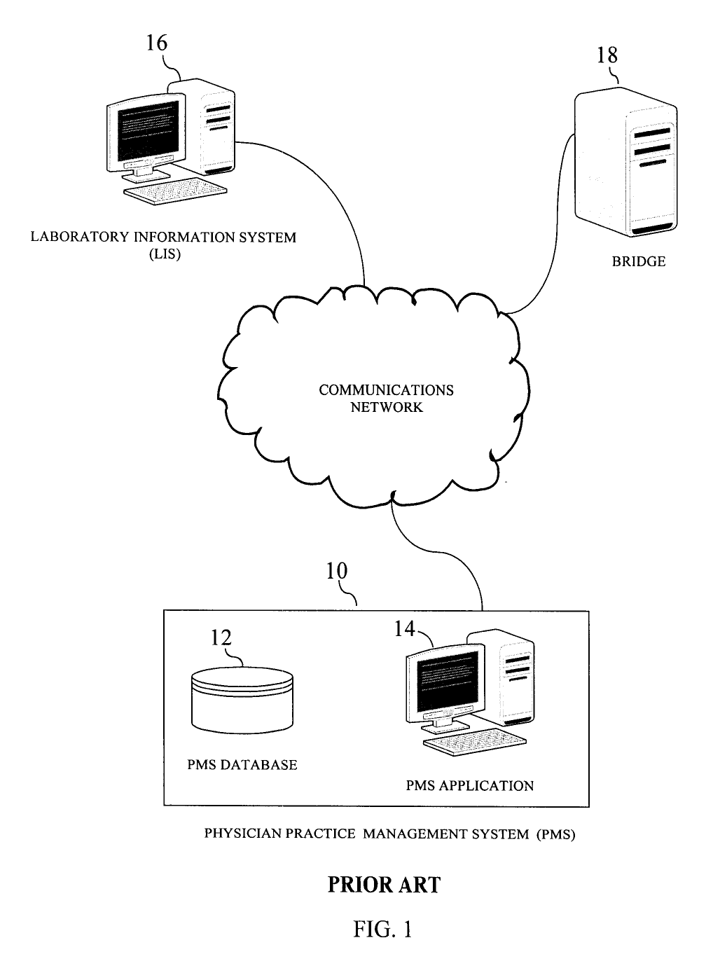

### DETAILED DESCRIPTION OF THE INVENTION

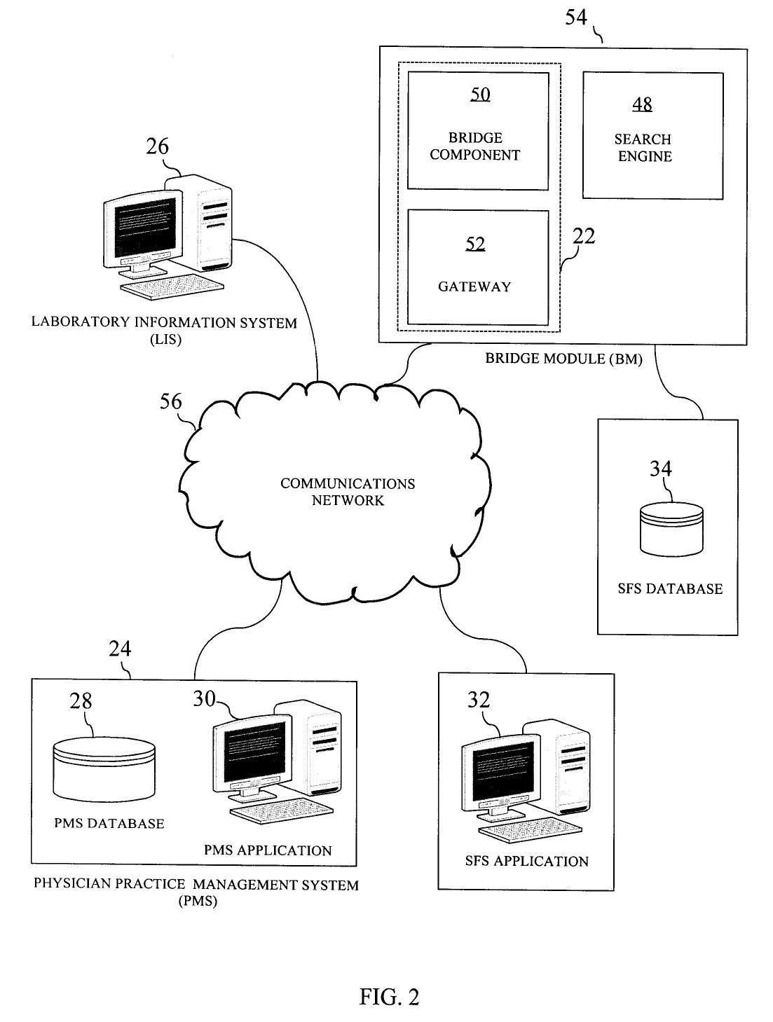

FIGS. 2, 3 and 5 illustrate a search and find system 20 and a bridge 22 constructed in accordance with the present invention. More particularly, the search and find system 20 and the bridge 22 are adapted for use in locating a desired patient record in a physician practice management system (PMS) 24 and then providing patient data relating to the desired record to a laboratory information system (LIS) 26. To facilitate consideration and discussion, the physician practice management system 24 and laboratory information system 26 will be discussed briefly below, followed by a detailed discussion of the search and find system 20 and the bridge 22.

The physician practice management system 24 has a construction and operation which is similar to those of a conventional physician practice management system. For instance, the physician practice management system 24 is adapted for use by a physician and/or his/her staff members, such as nurses, office managers, etc., (collectively hereinafter “the physician”) to store, retrieve, organize and otherwise manage information relating to his/her patients. In this regard, the physician practice management system 24 includes a PMS database 28 for storing patient records. These patient records (hereinafter “the PMS patient records”) can be electronic files, each of which corresponds to one of the patients. In an alternate embodiment, the PMS patient records can be stored in a single electronic file or two or more electronic files. Each of the PMS patient records includes patient data, such as patient demographic information (e.g., the patient name, address, telephone number or numbers, social security number, sex, etc.), billing/insurance information (e.g., primary and secondary insurer information) and other account information (e.g., information relating to a corresponding patient). The physician practice management system 24 also includes a PMS application 30, such as database and user interface software, for entering, retrieving and/or managing (e.g., revising, deleting, etc.) the patient records. The physician practice management system 24 can reside on a workstation or a server located in a physician's office. Alternatively, the physician practice management system 24 can reside on a remotely located server (e.g., a website) which can be accessed in a conventional manner (e.g., via the Internet, a local area network, etc.).

The laboratory information system 26 has a construction and operation which is similar to those of a conventional laboratory information system. For instance, the laboratory information system 26 is adapted for use by the physician to prepare and transmit a requisition or request form for a diagnostics test (e.g., a blood test, a urine analysis, etc.) to a laboratory (e.g., Quest Diagnostics, Inc., LabCorp®, etc.). The laboratory information system 26 can be configured to allow the physician to receive and download the results of the test upon its completion by the laboratory. The requisition may include one or more patient demographic and/or insurance data (which can be obtained by the physician in a manner to be discussed below), as well as a description of one or more tests ordered by the physician. The insurance data included in the requisition can be used by the laboratory to properly process a billing/insurance claim for the test. The laboratory information system 26 may be a web-based application residing on a remotely located server (e.g., a laboratory's server or a server in a hospital) for access by the physician in a conventional manner (e.g., via the Internet, etc.). Alternatively, the laboratory information system 26 can reside on a workstation or a server located in the physician's office.

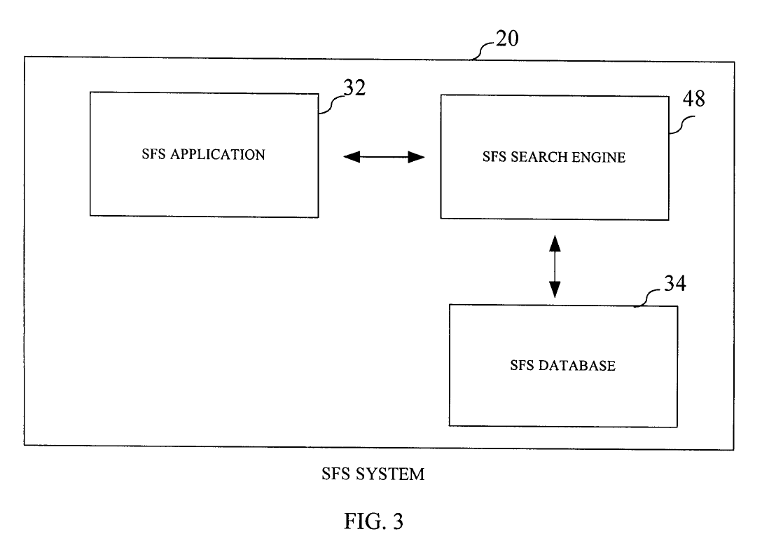

With reference to FIGS. 2 and 3, the search and find system 20 is adapted to facilitate the retrieval of desired patient data from the PMS database 28 of the physician practice management system 24 required for completing a requisition form for a diagnostics test. More particularly, the search and find system 20 is especially useful in locating a desired record stored in the PMS database 28 when a unique patient identifier (e.g., a patient chart number, social security number or another identifier) is not readily available to the physician. The search and find system 20 includes a search and find application (hereinafter “the SFS application”) 32, a search and find database (hereinafter the “SFS database”) 34, and a search engine 26, each of which will be described in detail hereinbelow.

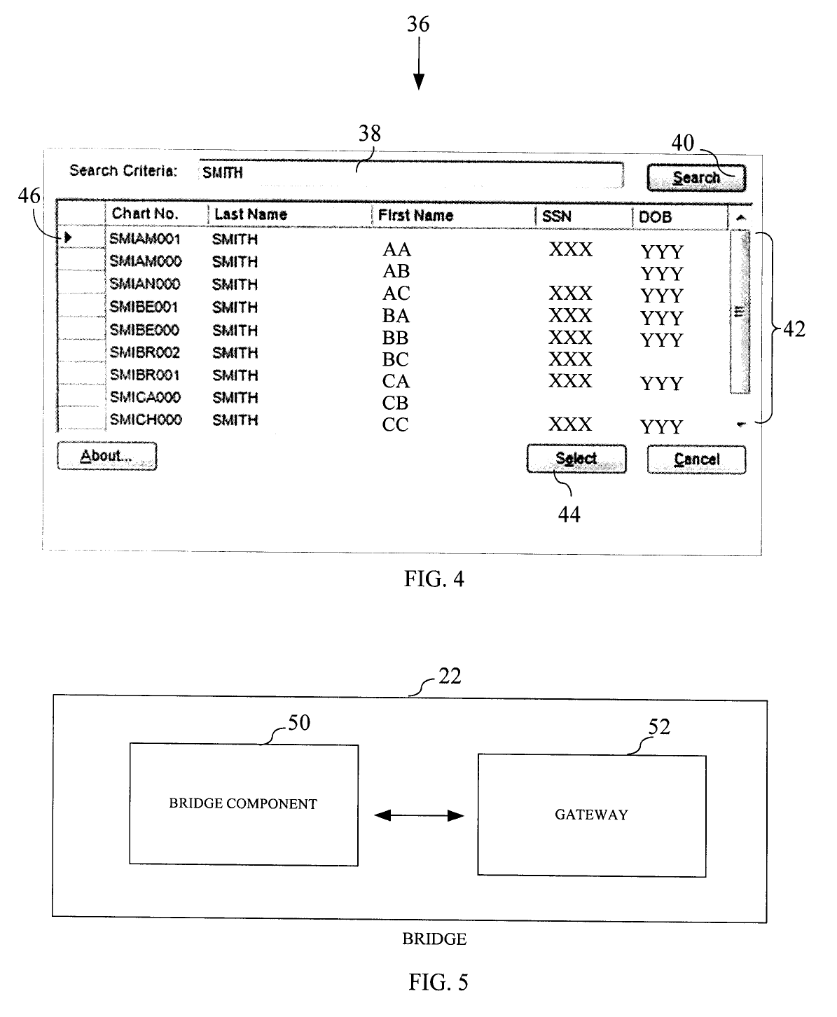

The SFS application 32 is adapted to allow the physician to conduct a search for patient data when a unique patient identifier corresponding to the patient is not known. The SFS application 32 is configured to provide a search screen 36 (see FIG. 4) with a search criteria text box 38 into which an appropriate search criterion or criteria can be entered. For instance, the physician may enter a search term that is known to him/her, such as the first or last name of the patient (e.g., “SMITH”), or a portion thereof e.g., “SM”). The search screen 36 also has a search key 40, a display box 42, a select key 44 and a screen cursor 46, which will be discussed in greater detail below. The SFS application 32 is configured to generate and send a request (hereinafter “search request”) based on entered search criteria to the bridge 22. The SFS application 32 is also adapted to display on the search screen 36 the results of the search retrieved from the SFS database 34. When the physician selects a “patient” displayed on the search screen 36, the SFS application 32 is configured to generate and send a request (hereinafter “bridge request” or “bridge look-up request”) containing a unique patient identifier to the bridge 22 for retrieving from the PMS database 28 patient data corresponding to the patient. The SFS application 32 can reside on a workstation or server located in the physician's office, or on a remotely located server accessible through a conventional manner (i.e., via the Internet).

The SFS database 34 is used for storing patient records (hereinafter “the SFS patient records”), each of which includes only a subset of the patient data contained in a corresponding PMS patient record. More particularly, each PMS patient record includes a full or complete set of patient data relating to a patient (i.e., patient demographic information, insurance/billing information and account information), such as the unique patient identifier, patient chart number, first name, last name, middle initial, address, patient city, social security number, date of birth, sex, primary and secondary insurance information, patient payment information, etc. Accordingly, each PMS patient record typically contains a very large amount of information. In contrast, each of the SFS patient records includes only a limited or minimum number of pre-selected searchable fields (e.g., the unique patient identifier, the patient chart number, the last name, the first name, the date of birth, the social security number of each patient) that are useful in conducting a quick and effective search. In one embodiment, the SFS database 34 and the bridge 22 may co-reside on a single workstation or server to expedite communication therebetween. In an alternate embodiment, the SFS database 34 and the bridge 22 may reside on different servers or workstations. The SFS database 34 can be constructed in a manner similar to those of conventional databases.

As shown in FIG. 3, the search and find system 20 also includes a search engine 48 for conducting a search through the SFS database 34 based on the search criteria provided thereto. More particularly, the search engine 48, which is constructed in a manner similar to those of conventional search engines, is adapted to receive a search request containing search criteria from the SFS application 32 and then extract patient data from the SFS application 32 based on such search criteria. Once the search is conducted, the search engine 48 is adapted to return the extracted patient data to the SFS application 32 for display on the search screen 36.

Referring now to FIGS. 2 and 5, the bridge 22 includes a bridge component 50, which is similar, in construction and operation, to a conventional bridge. More particularly, the bridge component 50 is a software application adapted to manage communication between the physician practice management system 24, the laboratory information system 26 and the search and find system 20. The bridge 22 also has a gateway 52 which is adapted to route a request received from the SFS application 32 to the bridge component 50 or to the search engine 48. More particularly, if the request is a search request (i.e., a request to conduct a search through the SFS database 34), then the gateway 52 routes same to the search engine 48. On the other hand, if the request is for a bridge look-up request (i.e., a request to retrieve patient data from the PMS database 28), the gateway 52 routes same to the bridge component 50. In one embodiment, the bridge component 50, the gateway 52 and the search engine 48 can be written or constructed as a single software component to form a bridge module 54 (see FIG. 2) residing on a single server or workstation together with the SFS database 34. In an alternate embodiment, the bridge component 50, the gateway 52 and the search engine 48 can be constructed as individual software components configured to interact with one another.

Requests generated by the SFS application 32 and search results returned thereto can be in any conventional format, such as HL7, ASTM, XML or delimited text format. For instance, a search request generated by the SFS application can be in the following XML format:

<SFSRCH><S>Smith</S><R>10</R><B>0</B></SFSRCH>

In the foregoing format, the term encapsulated between the legends <S> and <IS> denotes a search term entered by the user, while the number encapsulated between the legends <R> and </R> denote the maximum number of search results (i.e., records) to be returned from the search engine 48. Such number can be adjusted by the user via the SFS application 32 or be permanently preset in same. In addition, the number encapsulated between the legends <B> and </B> signifies that the request is a search request rather than a bridge look-up request, which can be in the following XML format:

<SFSRCH><S>1234</S><R>1</R><B>1</B></SFSRCH>.

Referring to the foregoing bridge look-up format, the term encapsulated between the legends <S> and </S> denotes a unique patient identifier for use in locating a corresponding PMS patient records in the PMS database 28. The number encapsulated between the legends <B> and </B> signifies that the request is a bridge look-up request rather than a search request.

The physician practice management system 24, the laboratory information system 26, the bridge 22 and the search and find system 20 are configured to communicate with each other over a communication network 56 (see FIG. 2). The communication network 56 may include wireline or wireless facilities, switched or packet (e.g., TCP/IP) connections and other conventional protocols/facilities (e.g., Ethernet, LAN, WAN, PVN, serial, etc.).

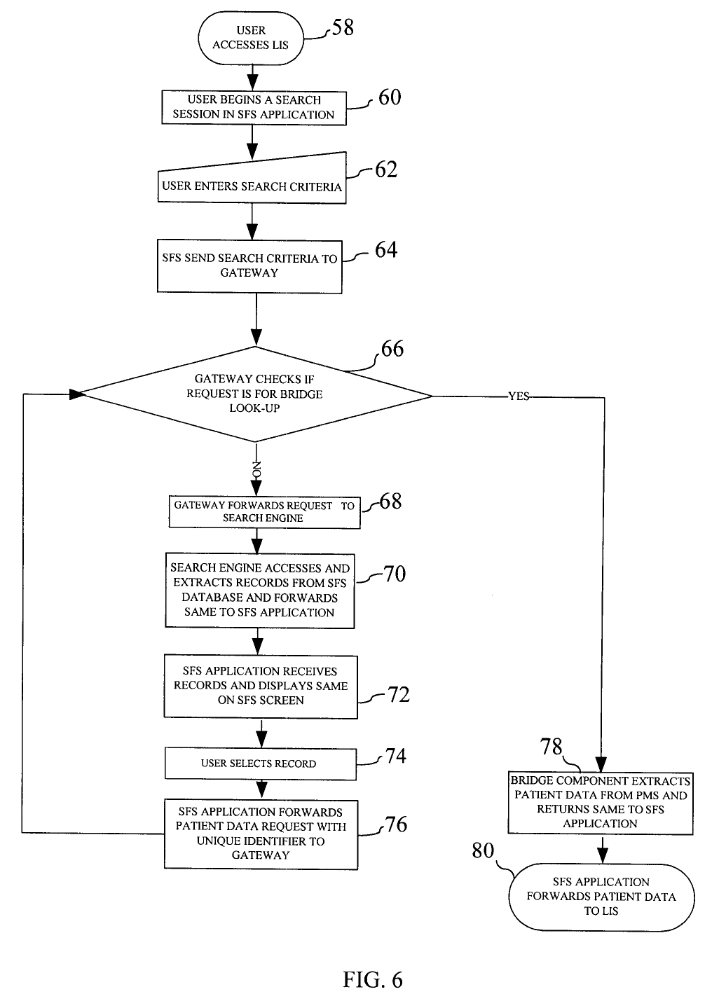

FIG. 6 illustrates an exemplary embodiment of a process in accordance with the present invention for preparing a requisition form for a diagnostic test for a patient with the aid of the search and find system 20. At block 58, the requisition is initiated by a physician by accessing the laboratory information system 26 through, for instance, a computer workstation in his/her office. By way of example, if the laboratory information system 26 is a web-based application, the physician accesses a website associated with the laboratory information system 26 and calls up an application which displays a preformatted requisition form on the monitor of the workstation in a conventional manner. If a unique patient identifier required for importing patient data into the requisition form from the physician practice management system 24 is not known or is not readily available, a search and find session is initiated (see block 60). More particularly, the search and find system 20 may be initiated by pressing a pre-programmed soft key on the workstation to trigger the SFS application 32 to display the search screen 36 (see FIG. 4) on the workstation's monitor. The SFS application 32 may run as an executable file, java applet, flash control, .Net control, activeX control or be called via a published API.

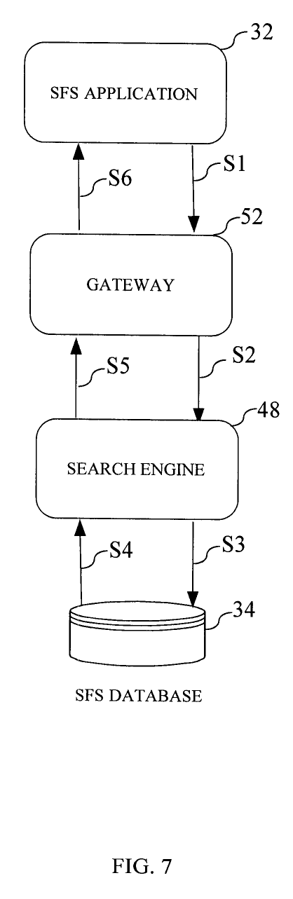

In order to request a search, the patient's first or last name or other search criteria known to the physician (e.g., the patient's chart number or social security number which are parts of the SFS patient record) is entered into the search textbox 38 of the search screen 36 (see block 62), and the search key 40 on the search screen 36 is pressed. In response, the SFS application 32 prepares and sends a search request containing the entered search criteria to the gateway 52 of the bridge module 54 through the communication network 56 (see block 64 in FIG. 6 and arrow S1 in FIG. 7). In response, the gateway 52 determines whether the received request is for a search request or a bridge look-up request (see block 66). Since the received request in this example is a search request (e.g., signified by the number “0” encapsulated the legends <B> and </B> in the search request format), the gateway 52 routes the request to the SFS search engine 48, at block 68, (as indicated by arrow S2 in FIG. 7). At block 70, the SFS search engine 48 conducts a search in the SFS database 34 and retrieves corresponding patient data (i.e., data associated with corresponding SFS patient records) located therein using a conventional process (as indicated by arrows S3 and S4 in FIG. 7) and forwards same to the gateway 52 (as indicated by arrow S5). The gateway 52 then forwards the retrieved patient data to the SFS application 32 (as indicated by arrow S6). At block 72, the SFS application 32 receives and displays the retrieved patient data in the display box 42 of the search screen 36 (see FIG. 4). If a record displayed on the display box 42 (e.g., see FIG. 4, the patient named SMITH AA) corresponds to the patient for whom the requisition is being prepared, the desired record is selected by moving the screen cursor 46 thereover (see FIG. 5), and pressing the select key 44 of the search screen 36.

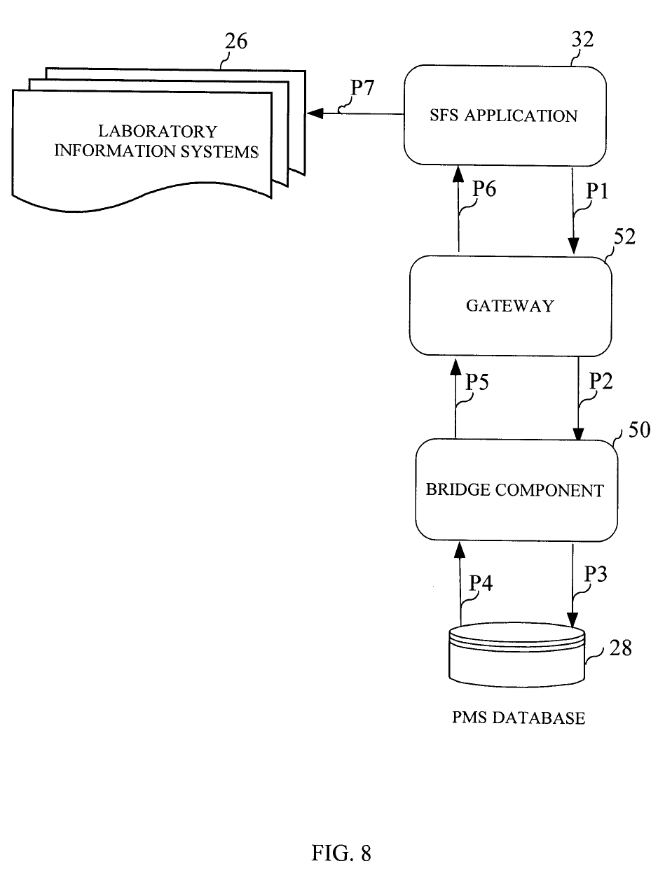

Once a selection is made, the SFS applications 32 retrieves the unique patient identifier (e.g., the displayed chart number) contained in the selected patient record, generate a bridge look-up request containing the retrieved unique patient identifier, and then sends same to the gateway 52 (see block 74 in FIG. 6 and arrow P1 in FIG. 8). In response, the gateway 52, at block 66, examines the request and determines that the request is for a bridge look-up (e.g., signified by the number “1” encapsulated between the strings <B> and </B> in the search request format). As a result, the request is forwarded to the bridge component 50 (as indicated by arrow P2 in FIG. 8). At block 76, the bridge component 50 accesses the PMS database 28 to locate a PMS patient: record corresponding to the unique patient identifier (as indicated by the arrow P3) and extracts therefrom one or more patient data (e.g., patient demographic data and insurance data) necessary to complete the requisition in a manner similar to that utilized by a conventional bridge (as indicated by arrow P4 in FIG. 8). The patient data retrieved from the PMS database 28 are then forwarded to the gateway 52 (as indicated by arrow P5), which in turn sends same to the SFS application 32 in a format that is usable by the laboratory information system 26 (as indicated by arrow P6). At block 78, the patient data received from the gateway 52 is forwarded by the SFS application 22 to the laboratory information system 26 (as indicated by arrow P7). The patient data received from the SFS application 32 are then auto-inserted into corresponding fields of the requisition form in a conventional manner. Once the requisition form is completed by the physician manually filling in the other required information, such as the type of tests ordered, the requisition form is submitted to the laboratory for processing.

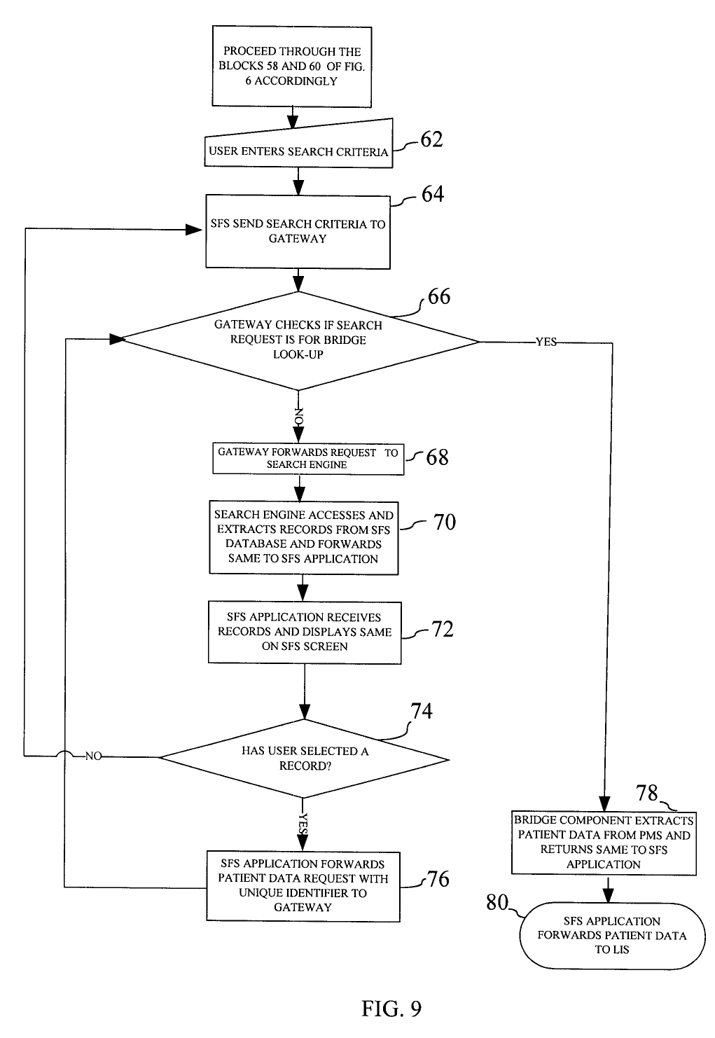

FIG. 9 illustrate a modified version of the process illustrated in FIG. 6. Unless stated below, the process illustrated in FIG. 9 is performed in a manner consistent with the process shown in FIG. 6. As described above, the search session conducted by the process illustrated in FIG. 6 is “static” in that the SFS application 32 stays inactive until the search key 40 is pressed by the physician to initiate a search request (see block 62 of FIG. 6). In the modified version of the process illustrated in FIG. 9, the SFS application 32 is configured to be “interactive” or “dynamic”. That is, the SFS application 32 is configured to continuously monitor search strings input into the search criteria text box 38 and automatically conduct a search every time a new search string or a set of new search strings is entered by the physician without the need for the physician to press the search key 40. The process illustrated in FIG. 9 will be described in greater detail below.

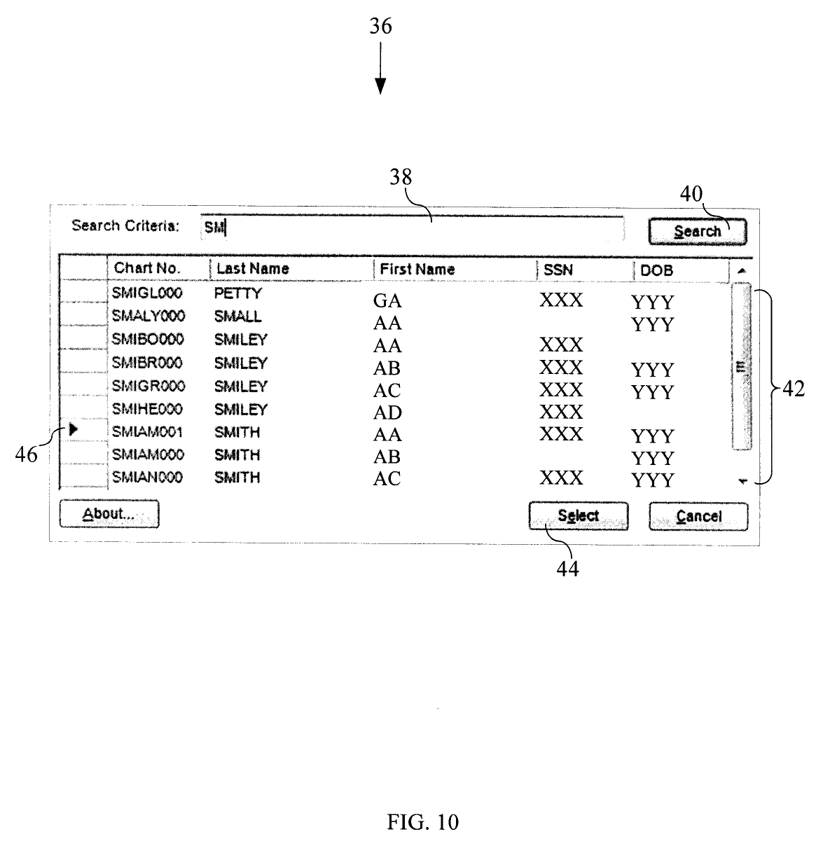

With reference to FIGS. 9 and 10, a search string (e.g., the letter “S”) is entered (e.g., typed) into the search textbox 38 of the search screen 36 (see block 62). The SFS application 32, which continuously monitors the entries into the search textbox 38, is able to detect the entry of the letter “S” and automatically prepares and sends a search request containing the search string to the gateway 52, at block 64. The process then performs the same steps associated with blocks 66, 68 and 70 illustrated in FIG. 6. At block 72, patient data each having a term beginning with “S” are display box 42 (see FIG. 10). The process illustrated in FIG. 9 differs from the process illustrated in FIG. 6 in that the SFS application 32 checks to determine if the physician has selected a patient in the display box 42, at block 74. If the physician, instead of making a selection, enters an additional search string (e.g., the letter “m”), the SFS application 32 detects such entry and automatically prepares and sends another search request containing the search string “SM” to the gateway 52 for conducting a search through the SFS database 34 and displays the updated search results on the display box 42 (see FIG. 10). The foregoing steps are repeated until a selection is made by the physician, in which case the process performs the same steps associated with the blocks 78, 80 in FIG. 6.

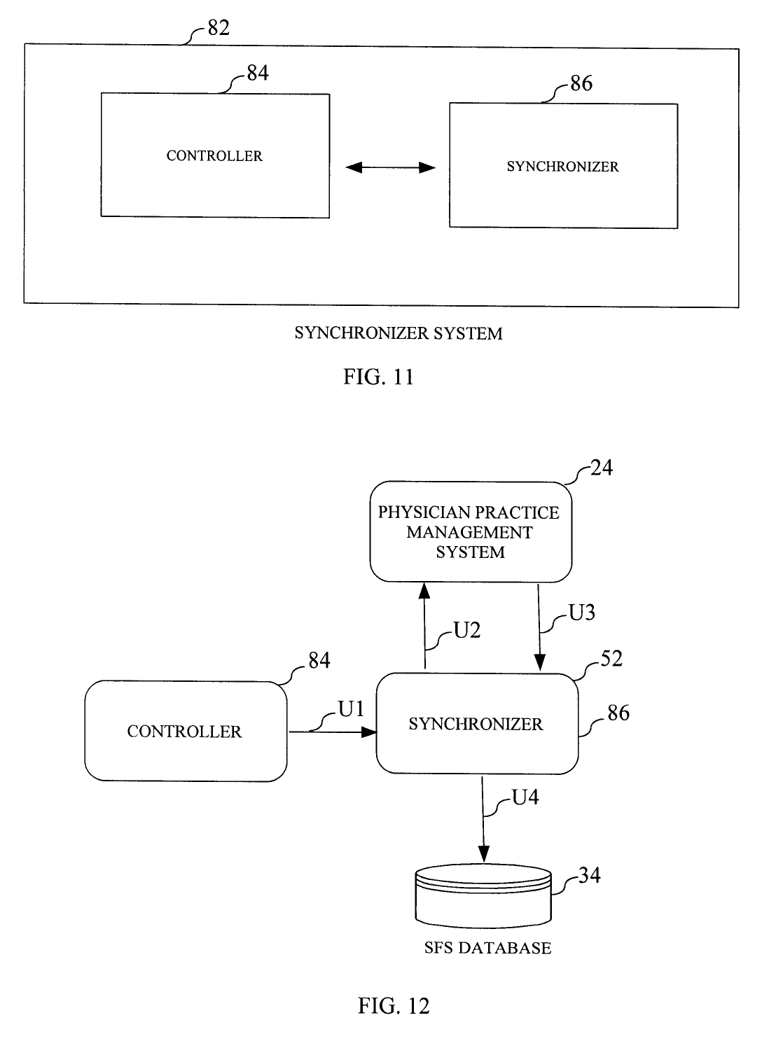

Referring now to FIG. 11, a synchronizer system 82 is provided for periodically updating the SFS database 34. The synchronizer system 82 includes a controller 84 and a synchronizer 86. The synchronizer system 82 may run as a Windows Service application in a low priority thread in the background. More particularly, the synchronizer system 82 periodically updates, at predetermined time intervals, particular fields of the SFS patient records in the SFS database 34 with the data residing in the same fields of the PMS patient records in the PMS database 28. The controller 84 is programmed to direct the synchronizer 86 to access the PMS database 28 at predetermine time intervals to conduct the synchronization. The synchronizer 82 normally resides on the same workstation or server as the bridge module 54.

Referring now to FIG. 12, if a full-synchronization mode is selected in the controller 84, the synchronizer 86 queries all PMS patient records in the PMS database 28 (as indicated in arrow U1). The synchronizer 86 then identifies all new records, changed records, and inactive records in the PMS database 28 (as indicated by arrow U2 in FIG. 12), and then adds new records, updates changed records, and deletes all inactive records in the SFS database 34 (as indicated by arrows U3 and U4).

If the full-synchronization mode is not pre-selected in the controller 84, the synchronizer 86 only queries the PMS patient records which have been added, changed or deleted in the PMS database 28 since the last synchronization was performed. The synchronizer 86 then adds new records, updates changed records, and deletes all inactive records in the SFS database 34.

AS described hereinabove, each of the PMS patient record stored in the PMS database 28 contains a substantially large amount of information, whereas only a portion of such information is replicated in the SFS database 34. As a result, a search for patient data can be conducted quickly and efficiently through the SFS database 34. In addition, the SFS database 34 can reside on the same server or workstation together with the bridge module 54 and search engine 48 to further enhance the searching speed.

It will be understood that the embodiments described herein are merely exemplary and that a person skilled in the art may make many variations and modifications without departing from the spirit and scope of the invention. All such variations and modifications, including those discussed above, are intended to be included within the scope of the invention as defined in the appended claims.

We claim:

1. Apparatus for use in retrieving information from a physician practice management system and providing the retrieved information to a laboratory information system, the physician practice management system including a first database for storing therein a plurality of first patient records, each of which corresponds to a patient, said apparatus comprising an application for generating a search request based on a search criterion supplied by a user; a second database for storing a plurality of second records, each of which corresponds to one of said first records stored in the first database; and a search engine for conducting a search through said second database in response to the search request received from said application and for retrieving at least one of the second records based on the search criterion, said application being configured to provide to the user the at least one of the second records retrieved from said second database.

2. The apparatus of claim 1, wherein each of the first records includes a set of first data associated with a patient; and wherein each, of the second records includes a set of second data, the set of second data of each of said second records being a subset of the set of first data of a corresponding one of the first records.

3. The apparatus of claim 2, wherein the set of second data of each of the second records has a limited set of searchable fields.

4. The apparatus of claim 3, wherein the searchable fields include an unique patient identifier field, a name field, a chart number field, a date of birth field and a social security number field, the set of first data of each of the first records having a set of fields, which are not included in the set of second data of a corresponding one of the second records.

5. The apparatus of claim 1, further comprising a bridge for communicating with said application and said search engine.

6. The apparatus of claim 5, wherein said bridge includes a gateway for receiving the search request from said application and transmitting the search request to said search engine, said gateway being configured to receive the at least one of the second records from said search engine and to transmit the at least one of the second records to said application.

7. The apparatus of claim 6, wherein said application is configured to generate a bridge request for retrieving a set of data associated with a desired one of the first records, said bridge including a bridge component for communicating with the physician practice management system, said gateway being configured to receive the bridge request from said application, to transmit the bridge request to the bridge component, to receive the data retrieved from said first database by said bridge component and to transmit the data to said application.

8. The apparatus of claim 5, wherein said second database and said bridge co-reside on a single machine.

9. The apparatus of claim 1, wherein said application is configured to provide a search screen for inputting the search criterion.

10. The apparatus of claim 9, wherein said search screen is configured to display the at least one of the second records retrieved from said second database for selection by the user.

11. Apparatus comprising a physician practice management system having a first database for storing a plurality of first patient records, each of which corresponds to a patient; a laboratory information system configured to receive patient information retrieved from said physician practice management system; an application for generating a search request based on a search criterion supplied by a user; a second database for storing a plurality of second records, each of which corresponds to one of the first records stored in said first database; a search engine for conducting a search through said second database in response to the search request received from said application and retrieving at least one of the second records from said second database based on the search criterion, said application being configured to provide the at least one of the second records to the user; and a bridge for communicating with said physician practice management system, said laboratory information system, said application and said search engine.

12. The apparatus of claim 11, wherein each of the first records includes a set of first data associated with a patient; and wherein each of the second records includes a set of second data, the set of second data of each of said second records being a subset of the set of first data of a corresponding one of the first records.

13. The apparatus of claim 12, wherein the set of second data of each of said second records has a limited set of searchable fields including an unique patient identifier field, a name field, a chart number field, a date of birth field and a social security number field, the set of first data of each of said first records includes a set of fields, which are not included in the set of second data of a corresponding one of the second records.

14. The apparatus of claim 11, wherein said bridge includes a gateway for receiving the search request from said application and transmitting the search request to said search engine, said gateway being configured to receive the at least one of the second records from said search engine and to transmit the at least one of the second records to said application.

15. The apparatus of claim 14, wherein said application is configured to generate a bridge request for retrieving a set of data associated with a desired one of the first records, said bridge including a bridge component for communicating with said physician practice management system, said gateway being configured to receive the bridge request from said application, to transmit the bridge request to the bridge component, to receive the data retrieved from said first database by said bridge component and to transmit the data to said application.

16. The apparatus of claim 11, wherein said application is configured to provide a search screen for inputting the search criterion, said search screen being configured to display the at least one of the second records for selection by a user.

17. Apparatus for use in retrieving information from a physician practice management system and providing the retrieved information to a laboratory information system, the physician practice management system including a first database for storing therein a plurality of first patient records, each of which corresponds to a patient, said apparatus comprising an application for generating a search request based on a search criterion supplied by a user; a second database for storing a plurality of second records, each of which corresponds to one of the first records stored in the first database; a search engine for conducting a search through said second database in response to the search request received from said application and for retrieving at least one of the second records from said second database based on the search criterion, said application being configured to provide the at least one of the second records to the user; and a synchronizing system for synchronizing the second records with the first records.

18. The method of claim 17, wherein each of the first records includes a set of first data associated with a patient; and wherein each of the second records includes a set of second data, each of which is a subset of the set of first data of a corresponding one of the first records.

19. A method for use in retrieving information from a physician practice management system and providing the retrieved information to a laboratory information system, the physician practice management system including a first database for storing therein a plurality of first patient records, each of which corresponds to a patient, said method comprising the steps of generating a search request based upon a search criterion supplied by a user; conducting a search through a second database in response to the search request, the second database storing therein a plurality of second records, each of which corresponds to one of the first records stored in the first database; retrieving at least one of the second records from the second database based on the search criterion; and providing the at least one of the second records retrieved from the second database to the user.

20. The method of claim 19, wherein the at least one of the second records includes a group of the second records, said method further comprising the steps of displaying the group of the second records for selection by the user; selecting one of the group of the second records; and retrieving from the first database data associated with one of the first records corresponding to the selected one of the group of the second records.

21. The method of claim 20, further comprising the step of transmitting the search request to a search engine, said conducting step and retrieving step being performed by the search engine in response to receipt of the search request.

22. The method of claim 21, wherein the search request is generated by an application, the search request being transmitted from the application to a bridge and from the bridge to a search engine during the performance of said transmitting step.

23. The method of claim 21, further comprising the step of transmitting the group of the second records to the application, said displaying step being performed by the application.

24. The method of claim 19, wherein each of the first records includes a set of first data associated with a patient; and wherein each of the second records includes a set of second data, the set of second data of each of said second records being a subset of the set of first data of a corresponding one of the first records.

25. The apparatus of claim 24, wherein the set of second data has a limited set of searchable fields including an unique patient identifier field, a name field, a chart number field, a date of birth field and a social security number field.
